(19) United States
(12) Patent Application Publication
(10) Pub. No.: US 2015/0019320 A1
(43) Pub. Date: Jan. 15, 2015

(54) SYSTEM AND METHOD FOR DETERMINING A DEFAULT ACCOUNT IN A MOBILE WALLET WHILE PROVIDING AN INCENTIVE TO ESTABLISH A DEFAULT ACCOUNT IN THE MOBILE WALLET

(71) Applicant: Qualcomm Incorporated, San Diego, CA (US)

(72) Inventors: JOSE MENENDEZ, San Diego, CA (US); SHRIRAM GANESH, San Diego, CA (US)

(21) Appl. No.: 13/941,358

(22) Filed: Jul. 12, 2013

(51) Int. Cl. G06Q 20/36; G06Q 30/02

(52) U.S. Cl. CPC G06Q 20/36; G06Q 30/0231
USPC 705/14.31

(57) ABSTRACT

A method and system for determining a default account in a mobile wallet of a portable computing device while providing an incentive to establish a default account in the mobile wallet includes receiving a confirmation that the mobile wallet exists in the portable computing device, such as a mobile phone. Communications may be established with the mobile wallet over a communications network so that it can be determined which financial account in the mobile wallet is the default account. Subsequently, a reward may be transmitted over the communications network if a default account matches an account of a financial service provider that is trying to determine their financial account in the mobile wallet is the default account. According to one embodiment, determining which financial account in the mobile wallet is the default account may include transmitting a request for a payment over the communications network to the portable computing device.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

PCDs may support use of mobile wallets. A mobile wallet or electronic wallet may comprise software running on PCD, such as a mobile phone, and which manages data that typically is embodied on conventional plastic credit cards, bank cards, and gift cards. The mobile wallet may support a plurality of virtual “cards” that correspond to traditional credit card and banking accounts. These virtual “cards” may be supported by different financial service providers (“FSPs”), such as a bank or credit card company.

One problem that exists in the art is the ability of a FSP to know which virtual card or account within a mobile wallet is used most frequently by the user of a PCD. Another problem that exists in the art is the ability of the FSP to persuade or to provide incentives to the user of a PCD to use a particular account as the default account in a mobile wallet.

### SUMMARY OF THE DISCLOSURE

A method and system for determining a default account in a mobile wallet of a PCD while providing an incentive to establish a default account in the mobile wallet includes receiving a confirmation that the mobile wallet exists in the PCD, such as a mobile phone. Communications may be established with the mobile wallet over a communications network so that it can be determined which financial account in the mobile wallet is the default account. Subsequently, a reward may be transmitted over the communications network if a default account matches an account of a FSP that originates the determination of which financial account in the mobile wallet is the default account.

According to one exemplary embodiment, determining which financial account in the mobile wallet is the default account may include a FSP transmitting a request for a payment over the communications network to the mobile wallet (whether on the PCD or in the cloud). Subsequently, the FSP can confirm whether that payment FSP has posted to an account of the FSP.

In another exemplary embodiment, determining which financial account in the mobile wallet is the default account may include receiving a message from the communications network that comprises information indicating at least one financial account that is associated with a particular vendor. In another embodiment, determining which financial account in the mobile wallet is the default account may include receiving a message from the communications network that comprises results of a survey taken against a proximity application program module.

The reward, which provides an incentive for a user to set a particular FSP account as the default account, may include an offer for a discount off of a future purchase. Alternatively, or additionally, the reward may include a percentage off of a total amount of transactions processed with the default account in the mobile wallet.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral encompass all parts having the same reference numeral in all Figures.

FIG. 1A is a diagram of system for determining a default account in a mobile wallet while providing an incentive to establish a default account in the mobile wallet;

FIG. 1B is a diagram related to the diagram of FIG. 1A in which a fractional charge is received by a first financial provider;

FIG. 1C is a diagram related to the diagram of FIG. 1A in which a fractional charge originating from a first FSP is received by a second financial provider;

FIG. 2A is a diagram of an alternate system for determining a default account in a mobile wallet while providing an incentive to establish a default account in the mobile wallet;

FIG. 2B is a diagram illustrating a user interface for selecting a default account in connection with a proximity application module;

FIG. 2C is a diagram illustrating a user interface that displays an incentive to establish a default account in a PCD;

FIG. 3 is a diagram of an alternate system for determining a default account in a mobile wallet while providing an incentive to establish a default account in the mobile wallet;

FIG. 4A is a flowchart illustrating a method determining a default account in a mobile wallet while providing an incentive to establish a default account in the mobile wallet;

FIG. 4B is a flowchart illustrating a sub-method or routine of FIG. 4A which corresponds with the system illustrated in FIGS. 1A-1C; and

FIG. 5 is a functional block diagram for a portable computing device (“PCD”), such as a mobile phone.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) wireless technology and four generation (“4G”), greater bandwidth availability has enabled more PCDs with a greater variety of wireless capabilities. Therefore, a PCD may include a cellular telephone, a pager, a personal digital assistant (“PDA”), a smartphone, a navigation device, or a hand-held computer with a wireless connection or link.

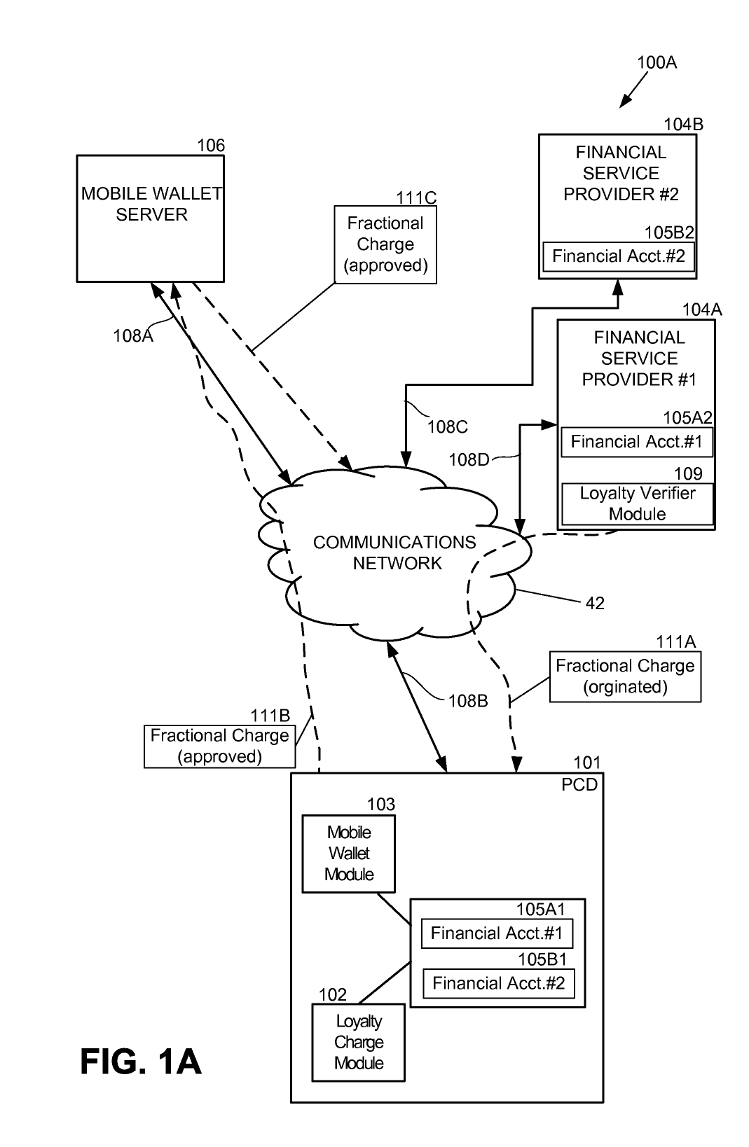

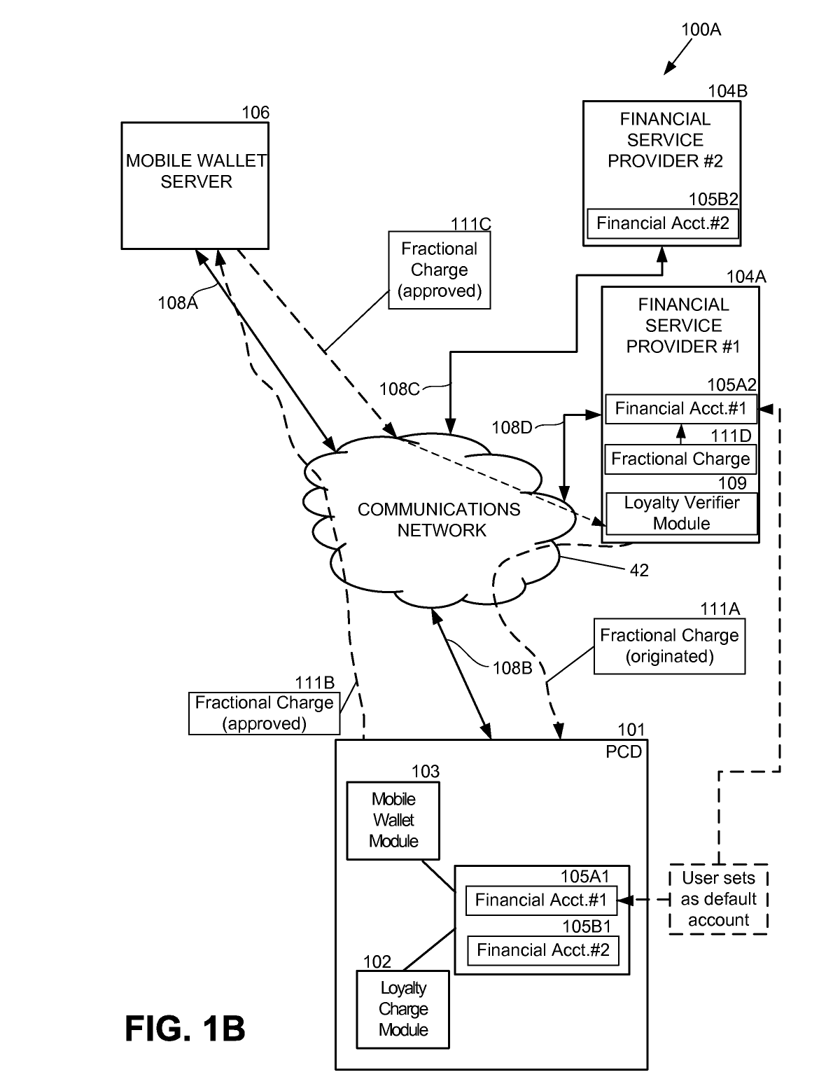

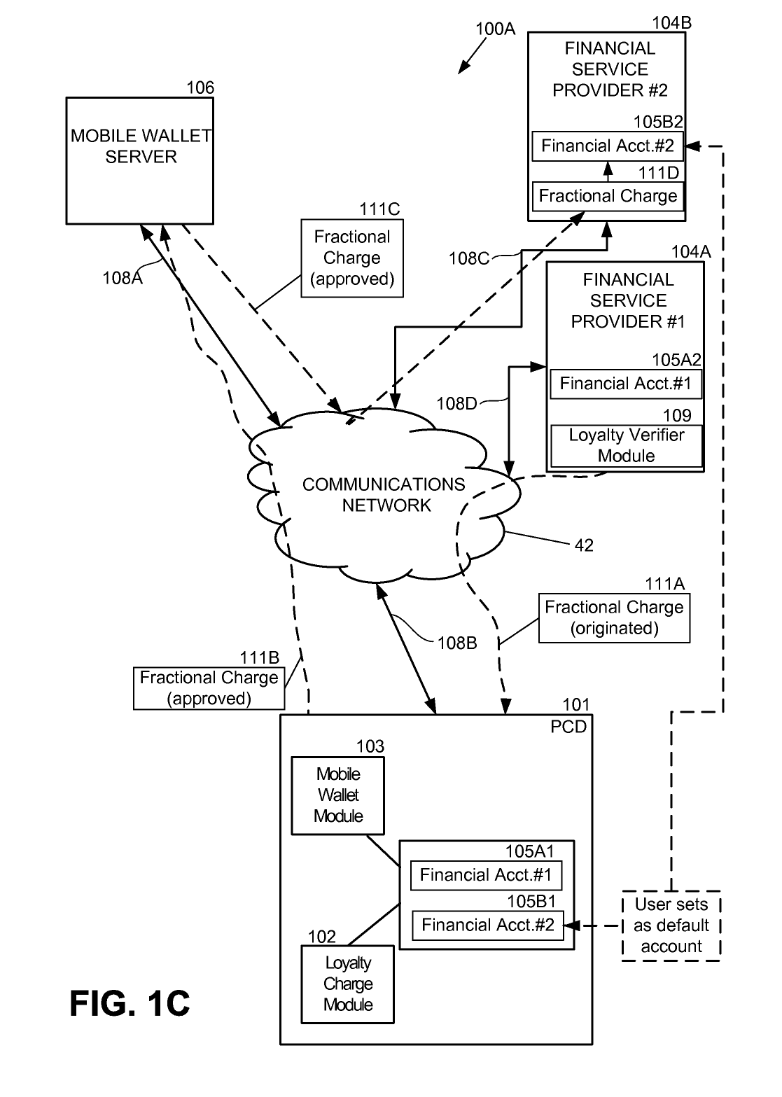

FIG. 1A is a diagram of system 100A for determining the default account 105 in a mobile wallet module 103 is a first Financial Acct.#1 (105A1) while providing an incentive to establish and maintain the first Financial Acct#1 (105A1) as the default account 105 in the mobile wallet module 103. The default account 105 is the account that is automatically set by the PCD 101 to complete a transaction. The system 100A may comprise a PCD 101; a mobile wallet module 103 running on the PCD 101; financial accounts 105A1, B1 managed by the mobile wallet module 103; a communications network 42; a mobile wallet computer server 106; a first financial service provider (“FSP”) (server) 104A; and a second FSP (server) 104B.

Each of these elements of the system 100 may be coupled to the communications network 42. The elements are coupled to the communications network 42 via communications links 108A-D. The links 108 illustrated in FIG. 1A may be wired or wireless links. Wireless links include, but are not limited to, radio-frequency (“RF”) links, infrared links, acoustic links, and other wireless mediums. The communications network 42 may comprise a wide area network (“WAN”), a local area network (“LAN”), the Internet, a Public Switched Telephony Network (“PSTN”), a paging network, or a combination thereof. The communications network 42 may also comprise specific proprietary sub-networks such as the Automatic Clearing House networks, the VISA™ card networks, the MASTERCARD™ card networks, the DISCOVER™ card networks, the AMERICAN EXPRESS™ card networks, and other similar financial networks as understood by one of ordinary skill in the art.

The PCD 101 may execute or run a mobile wallet application module 103 which supports a first financial account 105A1, and a second financial account 105B1. The first financial account 105A1 may be supplied and supported by the first FSP 104A while the second financial count 105B1 may be supplied and supported by the second FSP 104B.

The PCD 101 may execute or run a loyalty charge application module 102 as will be described in further detail below. The PCD may comprise at least one of a mobile telephone, a personal digital assistant, a pager, a smartphone, a navigation device, and a hand-held computer with a wireless connection or link.

A user of the PCD 101 may use the mobile wallet 103 when completing a financial transaction such as for a purchase of a good or service. For example, when a user of PCD 101 desires to purchase a product and/or service at a merchant, the user of PCD 101 may present PCD 101. Specifically, a display may be generated by the mobile wallet 103 in order to complete the transaction. The display generated by the mobile wallet 103 may comprise a financial account number and related data, such as a credit card account number and expiration date. Alternatively, the display generated by the mobile wallet 103 may comprise a machine-readable code such as a bar code for reading by a point of sale scanner and/or terminal. Alternatively, the display may merely indicate what action the user should take. For example, the display of the PCD may indicate “tap now” such that the PCD may complete a Near Field Communication transmission or other similar machine readable codes as understood by one of ordinary skill in the art.

The mobile wallet 103 may allow the user of the PCD 101 to establish a default account that is presented first and/or prior to any other accounts stored on the PCD 101 when the user desires to complete a financial transaction. It is this establishment of a default account that may be presented first in front of other financial accounts 105 which is one focus of the system 100. Furthermore, the default account may be used automatically for payment with minimal user intervention when the user receives a charge, for example when a user is notified a charge is being requested the user may merely select “accept” to have it paid with the default account in the mobile wallet module 103.

The financial accounts 105A1, B1 may be managed by the mobile wallet 103 which is in communication with a mobile wallet server 106 via the communications network 42. The financial accounts 105A1, B1 may correspond to financial accounts 105A2, B2 which are supported by first and second FSPs 104A, 104B.

The financial accounts 105 may comprise any type of account, such as, but not limited to, credit card accounts, bank accounts, stored value accounts, gift card accounts, etc. Each FSP 104 that is responsible for a respective financial account 105 may comprise at least one of a bank, a merchant, a credit card issuer, and other similar types of FSP 104 as understood by one of ordinary skill the art. A FSP 104 benefits from a financial account 105 that is designated as a default account within the mobile wallet 103 because such a default account will likely be used for the majority of transactions completed by the mobile wallet 103.

A loyalty verifier service module 109 which is part of FSP 104A may originate the fractional charge 111A that is sent to the wallet 103 of the PCD 101 for payment by the default financial account 105 established within the mobile wallet 103. The loyalty verifier service module 109 will then examine financial account 105A2 at FSP 104A to see if the fractional charge 111 is posted to that account. If so, it may confirm that Financial Acct.#1 (105A1) the default account within mobile wallet module 103. If the fractional charge 111 does not post to the account 105A2, it may confirm that Financial Acct.#1 (105A1) is not the default account within mobile wallet 103.

The loyalty verifier service module 109 may comprise software and/or hardware which are executed by a computer server at the FSP 104. The loyalty verifier service module 109 may track the “loyalty” and/or default accounts 105 for a plurality of PCDs 101 as will be described in further detail below.

A fractional charge 111 may comprise a percentage or a fraction of a predetermined amount of money that a FSP 104 may charge a user of a PCD 101 for participating in a “loyalty” program. The loyalty program may require the user of the PCD 101 to establish a default account 105 within the mobile wallet 103 where the default account is the financial account supplied by the FSP 104.

The FSP 104 may break up the predetermined amount of money charged for the loyalty program into smaller increments, like the fractional charge 111 illustrated in FIG. 1, such that the FSP 104 may charge smaller increments against the default account, such as Financial Account #1 (105A1) of FIG. 1B, managed by the mobile wallet 103 of each PCD 101. In this way, by using the smaller increments of the money charged for the loyalty program, the FSP 104 may periodically check to determine which financial account (either 105A1 or 105B1) has been designated by the user the PCD 101 as the default account within the mobile wallet 103.

In exchange for participating in this loyalty program in which the member of the loyalty program pledges to set the default account within the mobile wallet 103 to the financial account 105A1 managed by a specific FSP 104A, the FSP 104A may also reward the member in one or more various ways. For example, the FSP 104A may also issue payments to the member according to a set frequency, such as, but not limited to, a weekly basis, a monthly basis, and/or an annual basis. In addition to or as an alternative, the FSP 104A may also offer a percentage discount off of sales transactions at one or more product or service vendors when the financial account #1(105A1) corresponding to the FSP 104A is set as the default account (as illustrated in FIG. 1B) within the mobile wallet 103.

One exemplary reward scenario may be as follows:

The FSP 104A may issue $1 (or use any other type of currency, such as, but not limited to, a Euro or a Yen) per week as a reward as long as the default account in the mobile wallet 103 is set to the financial account #1 (105A1) supplied by the FSP 104A (See FIG. 1B). If the user of the PCD 101 using the mobile wallet 103 spends $1000 per month×12 months, this may equate to $12,000 per year in total transactions processed by the default account 105A1 within the mobile wallet 103. If the reward is set at $1×52 weeks in year, then such a reward would equate to $52 per year that is provided by the FSP 104 to the user of the PCD 101. The scenario translates into an effective cash back percentage of 0.43%. As appreciated by one of ordinary skill in the art, other currencies besides the U.S. dollar may be employed without departing from the scope of this disclosure. For example, other currencies include, but are not limited to, Japanese Yen, European Euros, Canadian dollars, Mexican pesos, as well as any other currency.

Another exemplary reward scenario may be as follows:

The FSP 104A may offer a 25% bonus cash back reward for purchases of goods and or services on a financial account 105A already offering 1% cash back when the default account is Financial Acct.#1 (105A1) corresponding to the FSP 104A and is charged using the mobile wallet 103. If the user of the PCD 101 using the mobile wallet 103 spends $1000 per month×12 months, this may equate to $12,000 per year in total transactions processed by the default account within the mobile wallet 103. The reward of 25% bonus cash back on $12,000 would be $12,000×(1%*25%)=$30 per year. The scenario translates into an effective cash back percentage of 0.25%.

In exchange for the reward and participation in this loyalty program, the FSP 104A may charge a predetermined amount of money which is usually a nominal total amount relative to a perception of the user of the PCD 101 and relative to the one or more rewards offered by the FSP 104A. For example, an exemplary nominal total amount for participating in the loyalty program may comprise a value of $3.65 per year. This exemplary value of $3.65 may be broken up into smaller increments or fractional charges 111 in which a U.S. penny ($0.01) is charged each day to the default account established within the mobile wallet 103.

In other words, this nominal total amount may correspond directly with a frequency in which the FSP 104A determines the default account status of Financial Acct. #1(105A1) managed by FSP 104A within the mobile wallet 103. Specifically, the FSP 104A may charge a predetermined amount of money that directly corresponds with the number of times the FSP 104A may check on the default account status of Financial Acct. #1 (105A1) managed by FSP 104A within the mobile wallet 103 by issuing fractional charges 111 relative to the nominal total amount.

As another example, if the FSP 104A desires to check the status of a member's account only on a weekly basis, then this nominal total amount for participating in the loyalty program may have a value which is evenly divided by the number 52—the number of weeks in a calendar year.

In a more specific example, the FSP 104A may charge a nominal total amount of $5.20 which allows the FSP to charge the member's default account within the mobile wallet 103 in increments of $0.10 (ten U.S. cents) per week for fifty-two weeks. Other frequencies for charging the default account within the mobile wallet 103 and other nominal amounts for participating in the loyalty program which correspond to different frequencies, besides annually (365) and weekly (52), are possible and are well within the scope of this disclosure as understood by one of ordinary skill in the art.

Referring back to FIG. 1A, the first FSP 104A may originate a fractional charge 111with its loyalty verifier service program module 109 that corresponds to the total nominal amount of a loyalty program which may be sent over the communications network 42 to the PCD 101. Specifically, the loyalty verifier module 109 of the first FSP 104A may send the fractional charge 111A to the loyalty charge application program module 102 running on the PCD 101. To participate in the loyalty program, the user of the PCD 101 gives authorization to the loyalty charge application program module 102 to use the default account 105A1 within the mobile wallet 103 when any fractional charges 111A from the first FSP 104A are received.

When a fractional charge 111A is received by the loyalty charge application program module 102, the loyalty charge application program module 102 instructs the mobile wallet 103 to pay the fractional charge 111A with the default account established by the user of the PCD 101. The mobile wallet 103 using the information from the default account sends a payment request that includes the fractional charge 111B over the communications network 42.

Referring now to FIG. 1B, this figure is a diagram related to the diagram of FIG. 1A in which the fractional charge 111D is received by a first financial provider 104A. This fractional charge 111D is received by the first FSP 104A from the mobile wallet server 106 over the communications network 42 ONLY if the default account within the mobile wallet 103 was assigned or set equal to financial account #1 (105A1) such as illustrated in FIG. 1B. When the fractional charge 111D is received by the first FSP 104A, the first FSP 104A may observe the fractional charge 111D posted to financial account #1 (105A1) which corresponds with the default financial account residing within the mobile wallet 103 of the PCD 101.

Referring now to FIG. 1C, this is a diagram related to the diagram of FIG. 1A in which a fractional charge 111D originating from a first FSP 104A is received by a second FSP 104B. This fractional charge 111D is received by the second FSP 104B over the communications network 42 ONLY if the default account within the mobile wallet 103 was assigned or set equal to financial account #2 (105B1) which corresponds to FSP #2 104B. When the fractional charge 111D is received by the second FSP 104B, the first FSP 104A WILL NOT OBSERVE the fractional charge 111D post to financial account #1 (105A2).

If the first FSP 104A DOES NOT OBSERVE the fractional charge 111D posted to financial account #1 (105A2) such as illustrated in FIG. 1C, then the first FSP 104A may discontinue paying any rewards to the user of the PCD 101. Alternatively, or in addition to, the first FSP 104A may pay rewards to the user of the PCD 101 based on a pro-rated share of reward money depending upon the frequency in which the first financial account #1 (105A1) (supplied by the first FSP 104A) is the default account for the mobile wallet 103.

For example, if the first FSP 104A discovers that the user of the PCD 101 has only set the first financial account #1 (105A1) as the default account for fifty-one out of the fifty-two weeks of a calendar year, then the first FSP 104A may pay a reward that is multiplied by the fraction of (51/52). Other partial rewards supplied by a FSP 104A are possible and are within the scope of this disclosure.

In order to conserve on fees that may be charged by credit card networks like the VISA™ card networks, the MASTERCARD™ card networks, the DISCOVER™ card networks, the AMERICAN EXPRESS™ card networks, and other similar financial networks, the FSP 104A and/or the mobile wallet module 103 and/or the mobile wallet server 106 may collect or authorize payment of fractional charges 111 according to a batching operation as understood by one of ordinary skill in the art.

A batching operation or the batching of transactions may comprise the gathering of a group of small transactions on the order of a predetermined frequency, like one time a week or one time a month, in which relatively small transactions comprising the fractional charge 111 (i.e. such as a penny in U.S. currency) are batched together before they are sent over the communications network 42 to the FSP 104.

In this way, the FSP 104A that charges each mobile wallet 103 the fractional charge 111 will know if the financial account #1 (105A1) associated with the FSP 104A has been set as the default account for the mobile wallet 103 when the batched fractional charges 111 are processed. Basically, when the financial account #1 (105A1) associated with a FSP 104A has been set as the default account for the mobile wallet 103 (such as illustrated in FIG. 1B), the FSP 104A will observe the fractional charge 111 being charged to financial account #1(105A2) as described above.

As noted previously, the fractional charge 111 may be originated by a loyalty verifier service program module 109 which is executed by a computer server at the FSP 104A. Alternatively, the fractional charge 111 may originate from the loyalty charge application program module 102 which is running on the PCD 101. The FSP 104A may set the frequency at which the loyalty charge application program module 102 generates the fractional charge 111 that is processed by the mobile wallet 103.

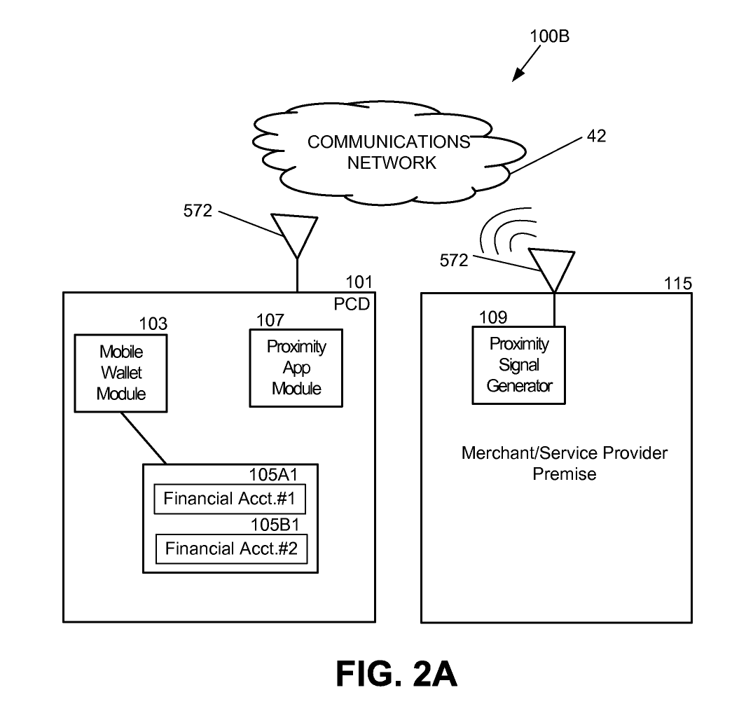

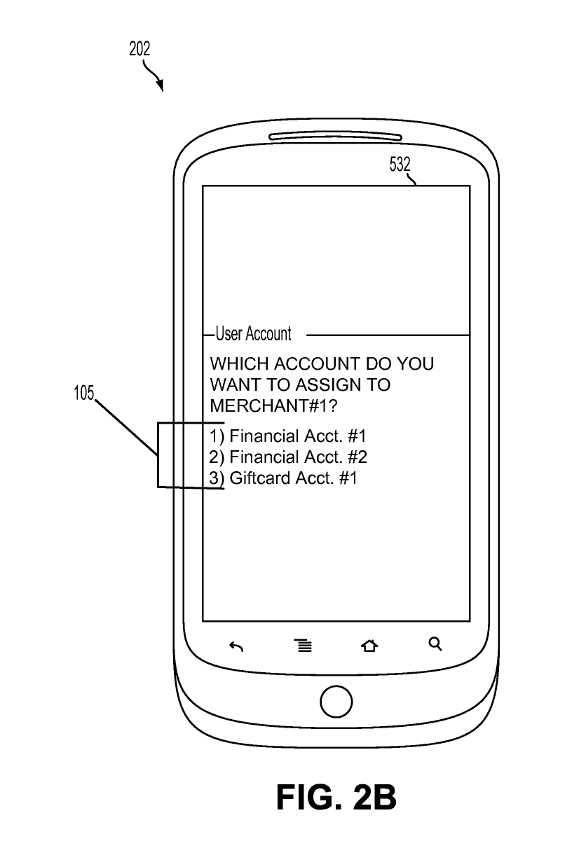

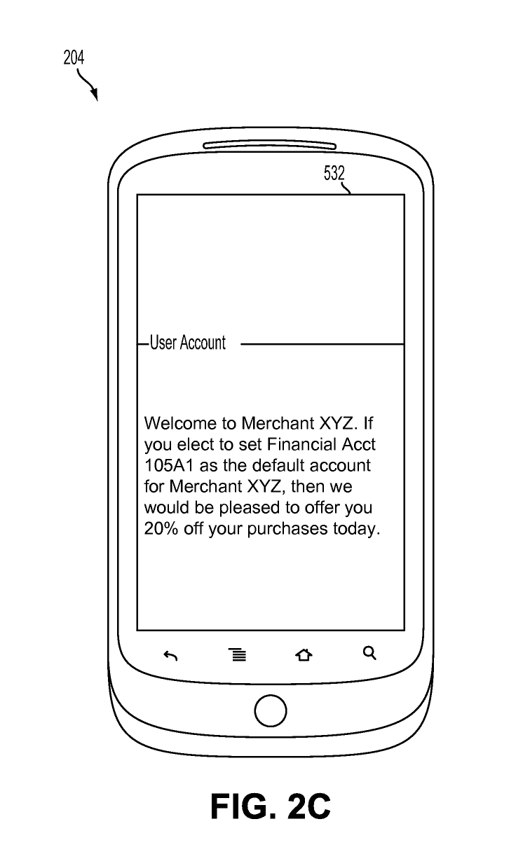

FIG. 2A is a diagram of an alternate system 100B for determining a default account in a mobile wallet 103 while providing an incentive to establish a default account in the mobile wallet 103. According to this exemplary embodiment, the PCD 101 may execute or run a proximity application program module 107 created by FSP 104. This proximity application program module 107 may work in conjunction with a proximity signal generator 109 which may be part of the premises 115 of a merchant and/or service provider.

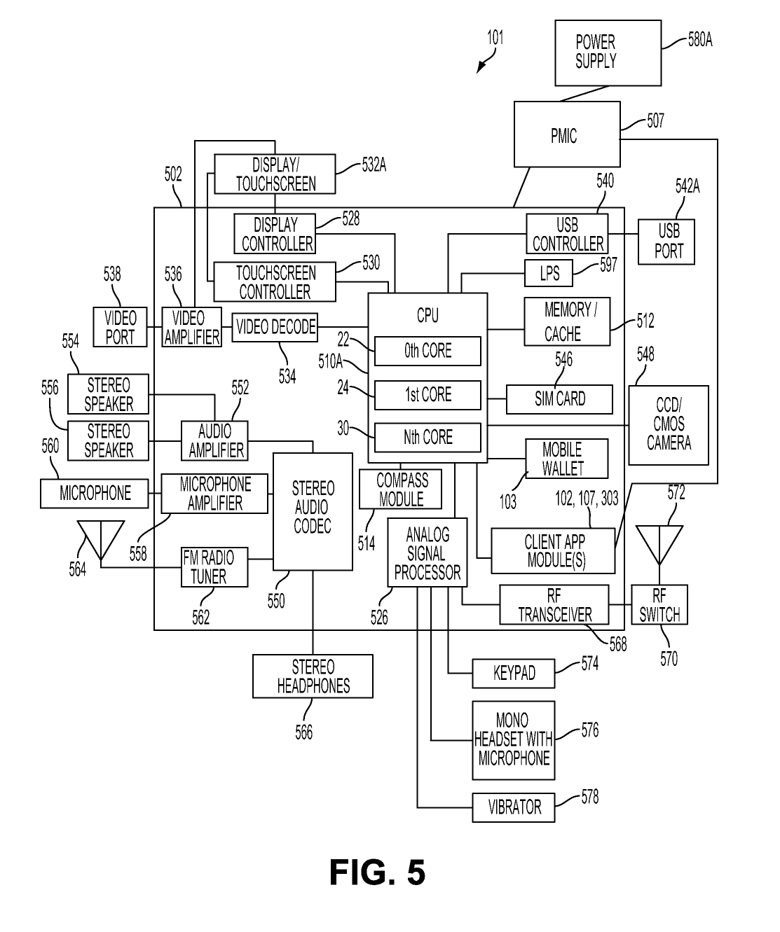

When the proximity application program module 107 detects that the PCD 101 is within a certain physical range of the location/premises 115 of the product or service vendor, the proximity application module 107 may capture or retrieve the default financial account 105 that was associated with the product or service vendor by the user of the PCD 101. The proximity location module 107 may work with a location positioning system (“LPS”) module 597 which is described below in connection with FIG. 5.

In this way, the proximity application program module 107 may capture or record the financial account 105 set as the default for the mobile wallet 103 for that merchant.

The proximity application program module 107 may detect that the PCD 101 is within a certain physical range of a product or service vendor by receiving wireless signals from the proximity signal generator 109. The proximity signal generator 109 may have an antenna 572 which relays its signals to the PCD 101 and its antenna directly. The proximity signal generator 109 may comprise any one of: satellites, including satellites that are part of the Global Positioning System (“GPS”), Galileo, GLONASS, NAVSTAR, GNSS, any system that uses satellites from a combination of these systems; or any satellite positioning system subsequently developed; Internet Protocol (“IP”) addresses received from WiFi services; WiFi service set identifiers (“SSIDs”) and/or Media Access Control (“MAC”) addresses from wireless local area networks (LANs); telecom signal identification; and/or triangulation from sources other than satellites, as understood by one of ordinary skill in the art.

According to this exemplary embodiment illustrated in FIG. 2A, the FSP 104 may receive a message from the proximity application program module 107 when the user of the PCD 101 registers a particular financial account to be associated with particular vendor locations and/or types, such as illustrated in FIG. 2B. Whenever the user of the PCD 101 changes the default account of the mobile wallet 103 for a particular product vendor and or service provider, the proximity application program module 107 may transmit a message to the FSP 104 alerting them of this change.

The FSP 104 may offer rewards/incentives, similar to those described above, so that the user the PCD 101 registers a particular financial account with particular product vendors or service vendors. One reward/incentive may include offering a percentage discount off of purchases if the user associates a particular financial account with a particular product vendor or service provider such as illustrated in FIG. 2C.

Referring again to FIG. 2B, this figure is a diagram illustrating a user interface 202 for selecting a default account in connection with a merchant. Whenever the user of the PCD 101 changes the default account for a particular product vendor and or service provider, the proximity application program module 107 may transmit a message over the communications network 42 to the FSP 104 alerting them of this change.

Referring now to FIG. 2C, this figure is a diagram illustrating a user interface 204 for displaying a reward for establishing a default account within a PCD 101 via the proximity application program module 107. In this exemplary embodiment, the reward is displayed. The reward includes an offering for a percentage discount off of purchases because the user has associated a particular financial account with a particular product vendor or service provider when the PCD 101 is within close proximity as detected by the proximity application program module 107.

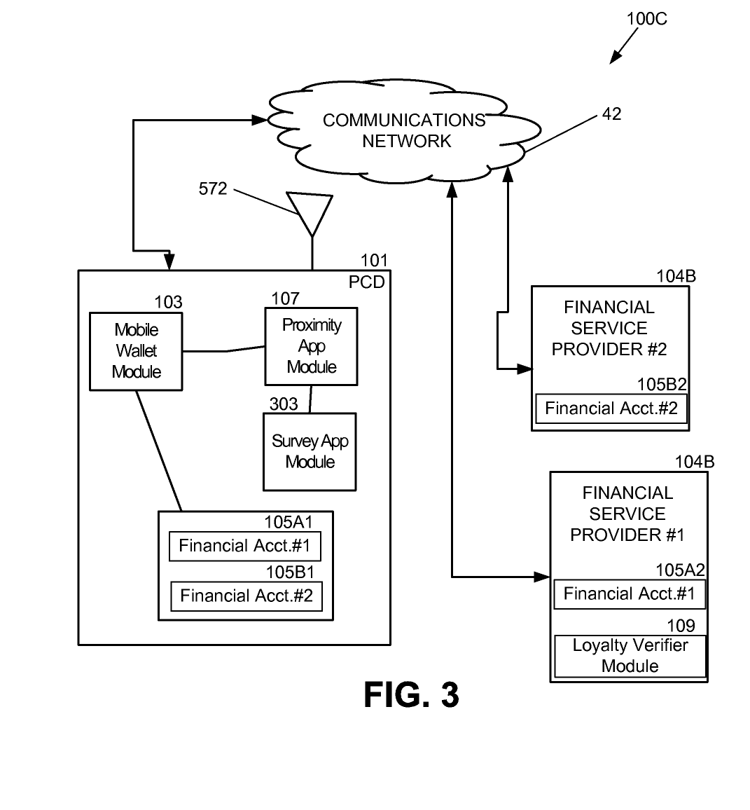

FIG. 3 is a diagram of an alternate system 100C for determining a default account in a mobile wallet 103 while providing an incentive to establish a default account in the mobile wallet 103. In addition to the proximity application program module 107 described above, an account surveying program module 303 may be provided which monitors the current status of the default financial account in mobile wallet module 103. This account surveying program module 303 may periodically check the status of the default financial account. The account surveying program module 303 may send messages over the communications network 42 to one or more FSPs 104 regarding the default financial account.

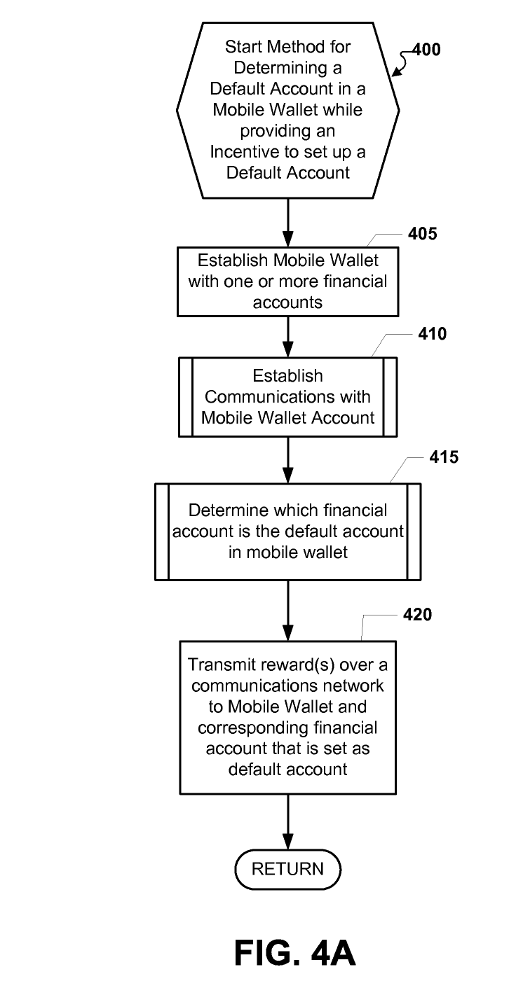

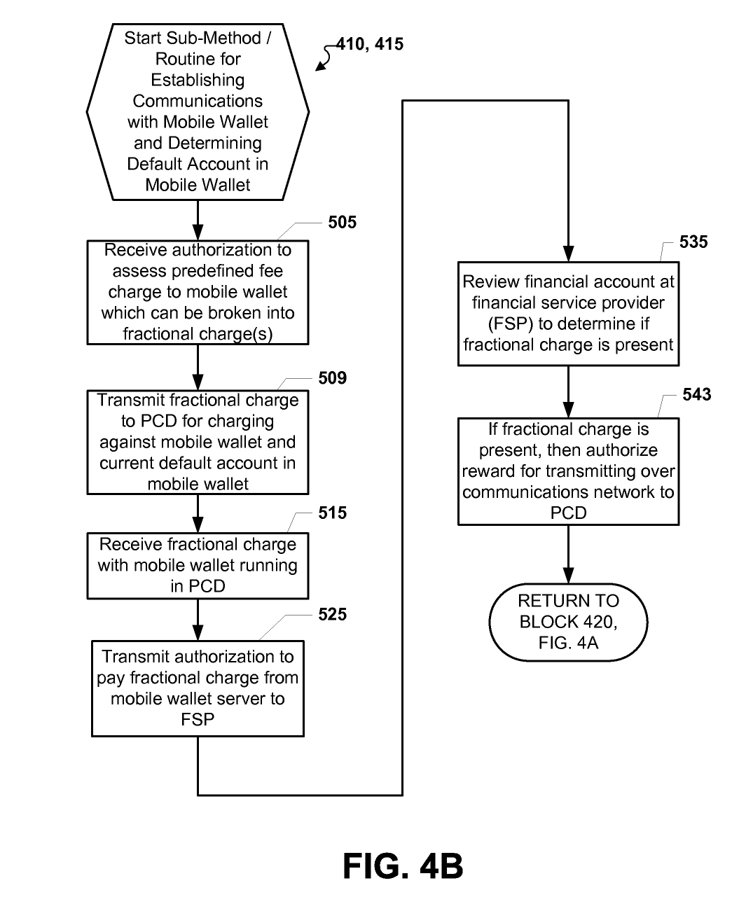

FIG. 4A is a flowchart illustrating a method 400 for determining a default account in a mobile wallet 103 while providing an incentive to establish a default account in the mobile wallet 103. Block 405 may be the first step of the method 400. In block 405, a mobile wallet 103 may be established within a PCD 101 which has a plurality of financial account (105A1, 105B1) such as illustrated in FIG. 1A.

Next, in routine block 410, communications may be established with a mobile wallet 103. Routine block 410 will be described in further detail below with respect to FIG. 4B and in connection with the exemplary embodiment illustrated in FIG. 1A. In routine block 410, the FSP 104A as illustrated in FIG. 1A, or the proximity application program module 107 of FIG. 2A, or the surveying application program module 303 of FIG. 3, may establish communication with the mobile wallet 103.

Next, in routine block 415, the financial account which is set, established or assigned by a user as the default account within a mobile wallet for a PCD 101 may be determined. Further details of this routine block 415 in connection with the exemplary embodiment of FIG. 1A will be described below in connection with FIG. 4B. In connection with the exemplary embodiment illustrated in FIG. 2A, the proximity application program module 107 may transmit messages over the communications network 42 to respective FSPs 104 to advise if financial accounts have been assigned to particular product vendors or service vendors. In connection with the exemplary embodiment illustrated in FIG. 3, the surveying application program module 303 may check the default account in mobile wallet module 303 and report this data over the communications network 42 to one or more FSPs 104.

In block 420, one or more FSPs 104 may transmit a reward over the communications network 42 to the PCD 101 having been mobile wallet 103 and in connection with a financial account (105A1, 105B1) that is set as the default account within the mobile wallet 103 (See FIGS. 1B & 1C). The process 400 may return and repeat.

FIG. 4B is a flowchart illustrating a sub-method or routines 410, 415 of FIG. 4A which has further details in support of the system illustrated in FIGS. 1A-1C. Block 505 is the first block of the sub method or routine 410, 415. In block 505, either a loyalty verifier service program module 109 running on a computer server 104A or a loyalty charge application program module 102 running on the PCD 101 may receive authorization to assess a fractional charge/predetermined fee 111 to the default account (See FIGS. 1B & 1C and default accounts) assigned within a mobile wallet 103 of a PCD 101.

Next, in block 509, either the loyalty verifier service program module 109 or the loyalty charge application program module 102 may transmit the fractional charge 111 to charge against the default account (See FIGS. 1B & 1C for default accounts) established within the mobile wallet of the PCD 101. The loyalty verifier service program module 109 may transmit its fractional charge 111 over the communications network 42 to the PCD 101.

Next, in block 515, the mobile wallet 103 may receive the fractional charge 111. In block 525, the mobile wallet module 103 may transmit the authorization to pay the fractional charge 111 using the default account 105 (FIG. 1B or 1C) to a FSP 104 over the communications network 42. As described previously, a delay may occur at block 525 if a batching operation is employed.

Next, in block 535, a FSP 104A may review financial account #1 (105A2) it maintains at its server to determine if the fractional charge 111 is present. Subsequently, in block 543, if the fractional charge is present, a reward may be authorized for transmission to the PCD 101 (See FIG. 1B). The routine or submethod may then return back to block 420 of FIG. 4A in which a reward is transmitted over the communications network 42 to the PCD 101.

FIG. 5 is a functional block diagram for a PCD 101, such as a mobile phone, that implements methods and systems for determining a default account in a mobile wallet 103 while providing an incentive to establish a default account in the mobile wallet. As shown, the PCD 101 includes an on-chip system 502 that includes a multi-core central processing unit (“CPU”) 510A and an analog signal processor 526 that are coupled together. The CPU 510A may comprise a zeroth core 22, a first core 24, and an Nth core 30 as understood by one of ordinary skill in the art. Instead of a CPU 510A, a digital signal processor (“DSP”) may also be employed as understood by one of ordinary skill in the art.

A power management integrated circuit (“PMIC”) 507 may be responsible for distributing power to the various hardware components present on the chip 502. FIG. 5 also shows that the PCD 102 may include a compass module 514 and a location positioning system (“LPS”) module 597.

The LPS module 597 may receive and transmit signals including, location parameters, from satellites, including satellites that are part of the Global Positioning System (“GPS”), Galileo, GLONASS, NAVSTAR, GNSS, any system that uses satellites from a combination of these systems, or any satellite positioning system subsequently developed. The LPS module 597 may also use other network information such as an Internet Protocol (“IP”) address, WiFi service set identifiers (“SSIDs”) from wireless local area networks (LANs), telecom signal identification, and/or triangulation from sources other than satellites collectively referred to as a Location Positioning System (“LPS”) in this disclosure.

As understood by one of ordinary skill in the art, however, the technology of all LPS systems is constantly being improved. New as yet unknown technologies for location determination and for determining location parameters of use with this system 101 may be used and are included in the meaning of “LPS” as described above.

In a particular aspect, one or more of the method steps described herein may be implemented by executable instructions and parameters, stored in the memory/cache 512, that form the loyalty charge application module 102, the proximity application module 107, and/or the survey application program module 303. These instructions that form these one or more modules 102, 107, and/or 303 may be executed by a CPU 510A, an analog signal processor 526, or any other processor to perform the computer implemented methods described herein.

Further, all processors, 510, 526, the memory 510, the instructions stored therein, or a combination thereof residing within the PCD 101 as described in this disclosure may serve as a means for performing one or more of the computer-implemented method steps described herein. As described above, the loyalty charge application module 102, the proximity application module 107, and/or the survey application program module 303 may comprise software and/or hardware for sharing determining a default account in a mobile wallet 103 while providing an incentive to establish a default account in the mobile wallet.

As illustrated in FIG. 5, a display controller 528 and a touchscreen controller 530 are coupled to the CPU 510A. A touchscreen display 532 external to the on-chip system 502 is coupled to the display controller 528 and the touchscreen controller 530.

FIG. 5 is a schematic diagram illustrating an embodiment of a PCD 101 that includes a video decoder 534. The video decoder 534 is coupled to the multicore central processing unit (“CPU”) 510A. A video amplifier 536 is coupled to the video decoder 534 and the touchscreen display 532. A video port 538 is coupled to the video amplifier 536. As depicted in FIG. 5, a universal serial bus (“USB”) controller 540 is coupled to the CPU 510A. Also, a USB port 542A is coupled to the USB controller 540.

Memory/cache 510 and a subscriber identity module (“SIM”) card 546 may also be coupled to the CPU 540A. Further, as shown in FIG. 5, a digital camera 548 may be coupled to the CPU 540A. In an exemplary aspect, the digital camera 548 is a charge-coupled device (“CCD”) camera or a complementary metal-oxide semiconductor (“CMOS”) camera.

As further illustrated in FIG. 5, a stereo audio CODEC 550 may be coupled to the analog signal processor 526. Moreover, an audio amplifier 552 may be coupled to the stereo audio CODEC 550. In an exemplary aspect, a first stereo speaker 554 and a second stereo speaker 556 are coupled to the audio amplifier 552. FIG. 5 shows that a microphone amplifier 558 may be also coupled to the stereo audio CODEC 550. Additionally, a microphone 560 may be coupled to the microphone amplifier 558. In a particular aspect, a frequency modulation (“FM”) radio tuner 562 may be coupled to the stereo audio CODEC 550. Also, an FM antenna 564 is coupled to the FM radio tuner 562. Further, stereo headphones 566 may be coupled to the stereo audio CODEC 550.

FIG. 5 further illustrates a radio frequency (“RF”) transceiver 568 may be coupled to the analog signal processor 526. An RF switch 570 may be coupled to the RF transceiver 568 and an RF antenna 572. As shown in FIG. 5, a keypad 574 may be coupled to the analog signal processor 526. Also, a mono headset with a microphone 576 may be coupled to the analog signal processor 526. Further, a vibrator device 578 may be coupled to the analog signal processor 526.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the disclosure. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for determining a default account in a mobile wallet of a portable computing device while providing an incentive to establish a default account in the mobile wallet, the method comprising:
receiving confirmation that the mobile wallet exists in the portable computing device;
establishing communications with the mobile wallet over a communications network;
determining which financial account in the mobile wallet is the default account; and
transmitting a reward over the communications network if a default account matches an account of a financial service provider (FSP) that originates the determination of which financial account in the mobile wallet is the default account.

2. The method of claim 1, wherein determining which financial account in the mobile wallet is the default account comprises transmitting a request for a payment over the communications network to the portable computing device.

3. The method of claim 1, wherein determining which financial account in the mobile wallet is the default account comprises receiving a message from the communications network that comprises information indicating at least one financial account that is associated with a particular vendor.

4. The method of claim 1, wherein determining which financial account in the mobile wallet is the default account comprises receiving a message from the communications network that comprises results of a survey taken against a mobile wallet module.

5. The method of claim 2, further comprising reviewing an account of the FSP on a computer server side to determine if the payment has posted to an account.

6. The method of claim 5, wherein the request for payment comprises a fractional charge corresponding to a total amount of money for a loyalty program.

7. The method of claim 1, wherein the reward comprises an offer for a discount off of a future purchase.

8. The method of claim 1, wherein the reward comprises a percentage of a total amount of transactions processed with the default account in the mobile wallet.

9. The method of claim 6, further comprising batching a plurality of fractional charges together before authorizing payment with a financial account corresponding to the default account.

10. The method of claim 1, wherein the portable computing device comprises at least one of a mobile telephone, a personal digital assistant, a pager, a smartphone, a navigation device, and a hand-held computer with a wireless connection or link.

11. A computer system for determining a default account in a mobile wallet of a portable computing device while providing an incentive to establish a default account in the mobile wallet, the system comprising:
a processor operable for:
receiving confirmation that the mobile wallet exists in the portable computing device;
establishing communications with the mobile wallet over a communications network;
determining which financial account in the mobile wallet is the default account; and
transmitting a reward over the communications network if a default account matches an account of a financial provider (FSP) that originates the determination of which financial account in the mobile wallet is the default account.

12. The system of claim 11, wherein the processor operable for determining which financial account in the mobile wallet is the default account further comprises the processor transmitting a request for a payment over the communications network to the portable computing device.

13. The system of claim 12, wherein the processor operable for determining which financial account in the mobile wallet is the default account comprises the processor operable for receiving a message over the communications network that comprises information indicating at least one financial account that is associated with a particular vendor.

14. The system of claim 11, wherein the processor operable for determining which financial account in the mobile wallet is the default account comprises the processor operable for receiving a message from the communications network that comprises results of a survey taken against a mobile wallet module.

15. The system of claim 12, further comprising a processor operable for reviewing an account of the FSP on a computer server side to determine if the payment has posted to an account.

16. The system of claim 15, wherein the request for payment comprises a fractional charge corresponding to a total amount of money for a loyalty program.

17. The system of claim 11, wherein the reward comprises an offer for a discount off of a future purchase.

18. The system of claim 11, wherein the reward comprises a percentage of a total amount of transactions processed with the default account in the mobile wallet.

19. The system of claim 16, comprising a processor operable for batching a plurality of fractional charges together before authorizing payment with a financial account corresponding to the default account.

20. The system of claim 11, wherein the portable computing device comprises at least one of a mobile telephone, a personal digital assistant, a pager, a smartphone, a navigation device, and a hand-held computer with a wireless connection or link.

21. A computer system for determining a default account in a mobile wallet of a portable computing device while providing an incentive to establish a default account in the mobile wallet, the system comprising:
means for receiving confirmation that the mobile wallet exists in the portable computing device;
means for establishing communications with the mobile wallet over a communications network;
means for determining which financial account in the mobile wallet is the default account; and
means for transmitting a reward over the communications network if a default account matches an account of a financial provider (FSP) that has control over the means for originating which financial account in the mobile wallet is the default account.

22. The system of claim 21, wherein the means for determining which financial account in the mobile wallet is the default account further comprises means for transmitting a request for a payment over the communications network to the portable computing device.

23. The system of claim 21, wherein the means for determining which financial account in the mobile wallet is the default account further comprises means for receiving a message from the communications network that comprises information indicating at least one financial account that is associated with a particular vendor.

24. The system of claim 21, wherein the means for determining which financial account in the mobile wallet is the default account further comprises means for receiving a message from the communications network that comprises results of a survey taken against a mobile wallet module.

25. The system of claim 22, further comprising means for reviewing an account of the FSP on a computer server side to determine if the payment has posted to an account.

26. The system of claim 21, wherein the request for payment comprises a fractional charge corresponding to a total amount of money for a loyalty program.

27. The system of claim 21, wherein the reward comprises an offer for a discount off of a future purchase.

28. The system of claim 21, wherein the reward comprises a percentage of a total amount of transactions processed with the default account in the mobile wallet.

29. The system of claim 26, further comprising means for batching a plurality of fractional charges together before authorizing payment with a financial account corresponding to the default account.

30. The system of claim 21, wherein the portable computing device comprises at least one of a mobile telephone, a personal digital assistant, a pager, a smartphone, a navigation device, and a hand-held computer with a wireless connection or link.

31. A computer program product comprising a computer usable medium having a computer readable program code embodied therein, said computer readable program code adapted to be executed to implement a method for determining a default account in a mobile wallet of a portable computing device while providing an incentive to establish a default account in the mobile wallet, said method comprising:
receiving confirmation that the mobile wallet exists in the portable computing device;
establishing communications with the mobile wallet over a communications network;
determining which financial account in the mobile wallet is the default account; and
transmitting a reward over the communications network if a default account matches an account of a financial provider (FSP) that originates the determination of which financial account in the mobile wallet is the default account.

32. The computer program product of claim 31, wherein determining which financial account in the mobile wallet is the default account comprises transmitting a request for a payment over the communications network to the portable computing device.

33. The computer program product of claim 31, wherein determining which financial account in the mobile wallet is the default account comprises receiving a message from the communications network that comprises information indicating at least one financial account that is associated with a particular vendor.

34. The computer program product of claim 31, wherein determining which financial account in the mobile wallet is the default account comprises receiving a message from the communications network that comprises results of a survey taken against a mobile wallet module.

35. The computer program product of claim 32, wherein the program code implementing the method further comprises reviewing an account of the FSP on a computer server side to determine if the payment has posted to an account.

36. The computer program product of claim 35, wherein the request for payment comprises a fractional charge corresponding to a total amount of money for a loyalty program.

37. The computer program product of claim 31, wherein the reward comprises an offer for a discount off of a future purchase.

38. The computer program product of claim 31, wherein the reward comprises a percentage of a total amount of transactions processed with the default account in the mobile wallet.

39. The computer program product of claim 36, the program code implementing the method further comprises batching a plurality of fractional charges together before authorizing payment with a financial account corresponding to the default account.

40. The computer program product of claim 31, wherein the portable computing device comprises at least one of a mobile telephone, a personal digital assistant, a pager, a smartphone, a navigation device, and a hand-held computer with a wireless connection or link.
